(19) United States
(12) Patent Application Publication
(10) Pub. No.: US 2019/0235984 A1
(43) Pub. Date: Aug. 1, 2019

(54) SYSTEMS AND METHODS FOR PROVIDING PREDICTIVE PERFORMANCE FORECASTING FOR COMPONENT-DRIVEN, MULTI-TENANT APPLICATIONS

(71) Applicant: salesforce.com, inc., San Francisco, CA (US)

(72) Inventors: ASHRAYA RAJ MATHUR, FREMONT, CA (US); SHWETA JOSHI, NEWARK, CA (US)

(73) Assignee: salesforce.com, inc., San Francisco, CA (US)

(21) Appl. No.: 15/883,259

(22) Filed: Jan. 30, 2018

(51) Int. Cl. G06F 11/34

(52) U.S. Cl. CPC G06F 11/3423; G06F 2201/88; G06F 11/3438; G06F 11/3495

(57) ABSTRACT

A method for providing performance data is provided. The method detects a current composition and layout of a graphical user interface (GUI), by a processor configured to present the GUI via a display device communicatively coupled to the processor, wherein the current composition and layout comprises reusable software components; identifies, by the processor, performance characteristics associated with historical activity of a user and with each of the reusable software components of the current composition and layout; creates a statistical forecasting model, by the processor, based on the performance characteristics; generates a performance score based on the statistical forecasting model, by the processor, wherein the performance score indicates a loading time of the GUI; and presents the performance score, by the display device communicatively coupled to the processor.

### TECHNICAL FIELD

Embodiments of the subject matter described herein relate generally to predictive performance forecasting in a software development, application design, configuration, and/or customization environment. More particularly, embodiments of the subject matter relate to predictive performance forecasting for particular components of a multi-tenant, server-based software application.

### BACKGROUND

A central objective of software application development is to provide the best possible performance of the application, including speed of operations and presentation of application elements by a computer display. Customizable software applications provide an end-user with the opportunity to incorporate and remove various software application components, according to his preference or technical requirements for the application. Thus, for customized applications, different combinations of components may be incorporated, presenting numerous distinct performance scenarios. In some cases, the end-user may be unaware of the performance-enhancing and/or performance-decreasing attributes of particular components or particular combinations of components used in a customizable software application.

Accordingly, it is desirable to provide additional data for customizable software applications during development, design, configuration, and/or customization. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for providing performance data. The method detects a current composition and layout of a graphical user interface (GUI), by a processor configured to present the GUI via a display device communicatively coupled to the processor, wherein the current composition and layout comprises reusable software components; identifies, by the processor, performance characteristics associated with historical activity of a user and with each of the reusable software components of the current composition and layout; creates a statistical forecasting model, by the processor, based on the performance characteristics; generates a performance score based on the statistical forecasting model, by the processor, wherein the performance score indicates a loading time of the GUI; and presents the performance score, by the display device communicatively coupled to the processor.

Some embodiments of the present disclosure provide a computing device for providing performance data. The computing device includes: a system memory element; a communication device, configured to establish a communication connection to a server system configured to store historical activity of a user; a display device, configured to present the performance data and a graphical user interface (GUI) comprising reusable software components; and at least one processor, communicatively coupled to the system memory element, the communication device, and the display device, the at least one processor configured to: detect a current composition and layout of reusable software components of a graphical user interface (GUI); identify performance characteristics associated with historical activity of a user and with each of the reusable software components of the current composition and layout; create a statistical forecasting model, by the processor, based on the performance characteristics; generate a performance score based on the statistical forecasting model, by the processor, wherein the performance score indicates a loading time of the GUI; and present the performance score, via the display device.

Some embodiments of the present disclosure provide a non-transitory, computer-readable medium containing instructions thereon, the instructions being configurable to be executed by a processor to perform a method. The method detects a current composition and layout of a graphical user interface (GUI), by the processor configured to present the GUI via a display device communicatively coupled to the processor, wherein the current composition and layout comprises reusable software components; identifies component timing metrics associated with each of the reusable software components, by the processor; measures user-specific timing metrics associated with the historical activity of the user, by the processor; creates a statistical forecasting model, by the processor, based on the component timing metrics and the user-specific timing metrics, wherein the statistical forecasting model comprises a waterfall chart of the component timing metrics and the user-specific timing metrics; generates a performance score based on the statistical forecasting model, by the processor, wherein the performance score indicates a loading time of the GUI; and presents the performance score, by the display device communicatively coupled to the processor.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a performance forecasting system, in accordance with the disclosed embodiments;

FIG. 2 is a functional block diagram of a computer system, in accordance with the disclosed embodiments;

FIGS. 3-6 are diagrams of an embodiment of reusable software components and associated statistical forecasting data, in accordance with the disclosed embodiments;

FIG. 7 is a flow chart that illustrates an embodiment of a process for providing performance data, in accordance with the disclosed embodiments;

FIG. 8 is a flow chart that illustrates an embodiment of a process for creating a statistical forecasting model, in accordance with the disclosed embodiments;

FIG. 9 is a flow chart that illustrates an embodiment of a process for identifying component timing metrics associated with each of the reusable software components, in accordance with the disclosed embodiments;

FIG. 10 is a flow chart that illustrates an embodiment of a process for identifying user-specific timing metrics, in accordance with the disclosed embodiments; and

FIG. 11 is a conceptual block diagram of a multi-tenant system in accordance with the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to systems and methods for predictively forecasting the performance of customized pages of component-based web applications, thus enabling optimization of performant user experiences. Contemplated herein is the capture of additional performance data for customizable software applications during development phases, and providing this information to the application users and administrators during the customization phases of the application. More specifically, the subject matter relates to computing a performance score for a particular, customized page based on performance characteristics associated with the combination of user-selected components incorporated into the page, and (ii) performance characteristics associated with historical activity of a user.

Certain terminologies are used with regard to the various embodiments of the present disclosure. As used herein, a component, a reusable component, or a reusable software component is a compact, configurable, and reusable element that may be positioned (i.e., “dragged and dropped”) onto a software application page in an “app builder” (i.e., software application builder) environment. Components may be incorporated into a page of a component-based web application, which is a software application comprising one or more components, and which may be implemented and accessible via an intranet or the Internet. One exemplary embodiment of a suitable environment is a Salesforce Lightning App Builder environment, including one or more Salesforce Lightning Pages which may be customized, by a user, through incorporation of one or more components.

Performance characteristics associated with customization of software application pages are associated with timing of execution and performance of operations, and associated with rendering of graphical elements onscreen. Performance characteristics associated with customization of software application pages may include, without limitation: (1) component performance characteristics (e.g., network characteristics, browser characteristics, client characteristics); and (2) user historical activity performance characteristics (e.g., user-specific network, browser, and client characteristics). Both categories are related to timing and latency of requests, responses, execution of operations, and component rendering. A performance score is a prediction of how quickly a software application page will load when a particular combination of components is incorporated into the page. The performance score is calculated using a statistical forecasting model that is based on performance characteristics of each component (e.g., network characteristics, browser characteristics, client characteristics) and historical activity of a user.

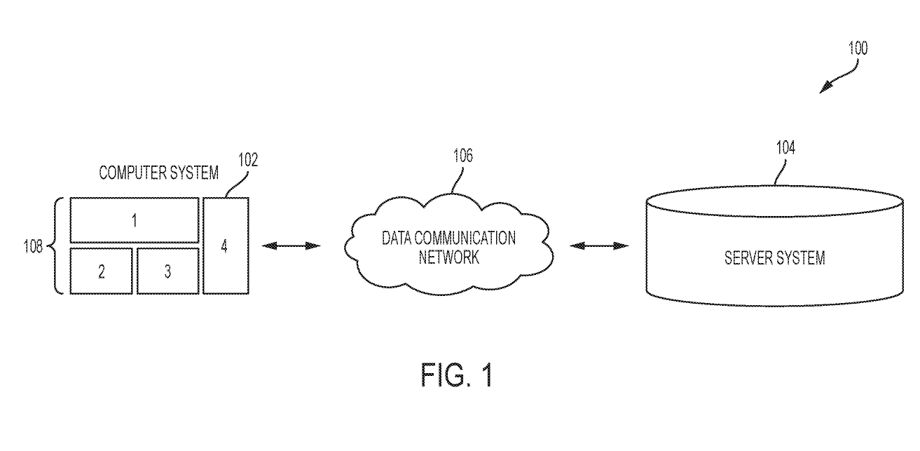

Turning now to the figures, FIG. 1 is a diagram of a performance forecasting system 100, in accordance with the disclosed embodiments. The performance forecasting system 100 operates to compute and present a predicted performance score associated with a combination of reusable software components selected by a user to populate a software application page. The performance forecasting system 100 may include, without limitation, a computer system 102 that communicates with at least one server system 104 via a data communication network 106. In practice, certain embodiments of the performance forecasting system 100 may include additional or alternative elements and components, as desired for the particular application.

The computer system 102 may be implemented by any computing device that includes at least one processor, some form of memory hardware, a user interface, and communication hardware. For example, the computer system 102 may be implemented using desktop computer and/or a personal computing device, such as a tablet computer, a laptop computer, a personal digital assistant (PDA), a smartphone, or the like. The computer system 102 is implemented as an end-user device that loads an application from an application server (e.g., server system 104).

The server system 104 may include any number of application servers, and each server may be implemented using any suitable computer. In some embodiments, the server system 104 includes one or more dedicated computers. In some embodiments, the server system 104 includes one or more computers carrying out other functionality in addition to server operations. The server system 104 includes all application server infrastructure and databases relevant to application page building and customization, as described herein. The server system 104 may store and provide any type of data used to build and customize a software application page, and to calculate a performance score associated with reusable software components. Such data may include, without limitation: a software application page building and customization platform, reusable software components, browser processing times, network processing times, server processing times, user browser preferences, user device timing characteristics, performance score and performance score weighting calculation data, and other data compatible with the computer system 102.

The computer system 102 communicates with the server system 104 via wired and/or wireless communication connection. The computer system 102 and the server system 104 are generally disparately located, and the computer system 102 communicates with the server system 104 via the data communication network 106. The data communication network 106 is a transport/network “layer”. The data communication network 106 may be any digital or other communications network capable of transmitting messages or data between devices, systems, or components. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links or network connections supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, and/or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

During typical operation, the computer system 102 accesses (via the server system 104), executes, and presents a software application page building and customization platform and a plurality of user-selectable, reusable software components 108. The computer system 102 is configured to receive user selections of particular reusable software components 108 for incorporation into the user's software application page. Once the reusable software components 108 are incorporated into the software application page, performance of the software application page is affected in various ways. Generally, the software application page performance may depend on performance characteristics of: (i) each of the reusable software components 108, (ii) the computer system 102 hardware and network connection, and (iii) the server system 104 hardware and network connection. As disclosed herein, the computer system 102 detects and identifies these performance characteristics, and then computes and presents a performance score for a current composition and layout of the software application page, wherein the current composition and layout comprises the reusable software components 108 incorporated into the software application page.

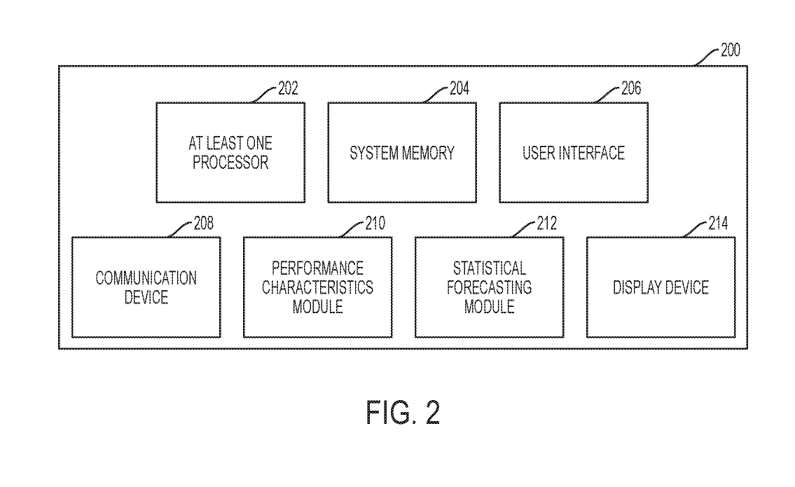

FIG. 2 is a functional block diagram of a computer system 200, in accordance with the disclosed embodiments. It should be noted that the computer system 200 can be implemented with the computer system 102 depicted in FIG. 1. In this regard, the computer system 200 shows certain elements and components of the computer system 102 in more detail. The computer system 200 generally includes, stores, maintains, operates, and/or executes, without limitation: at least one processor 202; system memory 204 hardware; a user interface 206; a communication device 208; a performance characteristics module 210; a statistical forecasting module 212; and a display device 214. These elements and features of the computer system 200 may be operatively associated with one another, coupled to one another, or otherwise configured to cooperate with one another as needed to support the desired functionality, as described herein. For ease of illustration and clarity, the various physical, electrical, and logical couplings and interconnections for these elements and features are not depicted in FIG. 2. Moreover, it should be appreciated that embodiments of the computer system 200 will include other elements, modules, and features that cooperate to support the desired functionality. For simplicity, FIG. 2 only depicts certain elements that relate to the techniques described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to, and communicates with, the system memory 204. The system memory 204 is configured to store any obtained or generated data associated with storing, maintaining, and executing an AI entity used to conduct text-based, voice-based, and/or video-based online conversations (e.g., “chat”) with a user. The system memory 204 may be realized using any number of devices, components, or modules, as appropriate to the embodiment. Moreover, the computer system 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the computer system 200. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The user interface 206 may include or cooperate with various features to allow a user to interact with the computer system 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the computer system 200. For example, the user interface 206 could be manipulated by an operator to select and execute a software application “app builder” platform, and to select various reusable software components for incorporation into a software application page, as described herein.

In certain embodiments, the user interface 206 may include or cooperate with various features to allow a user to interact with the computer system 200 via graphical elements rendered on a display element (e.g., the display device 214). Accordingly, the user interface 206 may initiate the creation, maintenance, and presentation of a graphical user interface (GUI). In some embodiments, the software application “app builder” platform may be implemented as a GUI presented by the display device 214, and which is configured to receive user input via the user interface 206. In certain embodiments, the display device 214 implements touch-sensitive technology for purposes of interacting with the GUI. Thus, a user can manipulate the GUI by moving a cursor symbol rendered on the display device 214, or by physically interacting with the display device 214 itself for recognition and interpretation, via the user interface 206.

The communication device 208 is suitably configured to communicate data between the computer system 200 and one or more user computer systems (e.g., user computer system 102 of FIG. 1) and one or more server systems (e.g., server system 104 of FIG. 1). The communication device 208 may transmit and receive communications over a wireless local area network (WLAN), the Internet, a satellite uplink/downlink, a cellular network, a broadband network, a wide area network, or the like. As described in more detail below, data received by the communication device 208 may include, without limitation: a software application page building and customization platform, reusable software components, browser processing times, network processing times, server processing times, user browser preferences, user device timing characteristics, performance score and performance score weighting calculation data, and other data compatible with the computer system 200. Data provided by the communication device 208 may include, without limitation, user selections of reusable software components and the like.

The performance characteristics module 210 is configured to obtain timing metrics and other performance characteristics associated with particular reusable software components, network connectivity, server capabilities and configurations, a user-selected internet browser and other user-selected computing equipment, and other variables associated with the computer system 200. The performance characteristics module 210 obtains the timing metrics and other performance characteristics associated with reusable software components, and the like, via instrumentation. Performance instrumentation and logging enables the automated capture of performance metrics. Each layer of the software application is instrumented to enable capturing the performance characteristics for each user, and for each page. Software application layers include the client device (e.g., the computer system 200; see FIG. 1, reference 102), the network (see FIG. 1, reference 106), and the server communicating with the client device via the network (see FIG. 1, reference 104).

Client device metrics may include, without limitation: browser processing time (e.g., render, layout, paint), Javascript execution time, component creation time, and component rendering time is instrumented for each component. Network metrics may include, without limitation: total network latency, request size, and response size are instrumented for each network/server request. Latency is the time taken from the source sending a packet to the destination receiving it. In exemplary embodiments of the software application, network latency for each server request is the time spent between the client device making a request and the client device receiving a response, excluding the time spent on the server. Server metrics may include, without limitation: total server response time and the breakdown of the server response time for each Application Programming Interface (API) and/or Structured Query Language (SQL) call on the server.

Instrumenting the client device and server for each request helps measure the total network latency. The client device is instrumented to record the time when each server request (e.g., an XML Http Request (XHR) request) is sent and the time when each corresponding server response (e.g., an XHR response) is received. On the server side, the server start time and end time is similarly captured. The total server time equals the difference between a server end time and a server start time (total server time=server end time−server start time). The server metrics are appended to the response and sent to the client. The network latency is calculated based on the instrumented server metrics, as follows: The total network latency equals the difference between a response end time and a request start time, subtracting the total server time (total network latency=response end time−request start time−total server time).

The statistical forecasting module 212 is configured to use the timing metrics and other performance characteristics, obtained by the performance characteristics module 210, to perform calculations associated with a performance score for a current configuration of reusable software components of a software application page. In some embodiments, the statistical forecasting module 212 is further configured to use the timing metrics and other performance characteristics to calculate a performance weighting score for individual reusable software components of a current configuration, which indicates performance of one reusable software component in the current configuration.

To perform these calculations, the statistical forecasting module 212 generates a statistical forecasting model that provides the performance score for a current configuration of reusable software components and/or a performance weighting score for a particular reusable software component of the current configuration. The statistical forecasting model may be implemented as a waterfall chart, a timeline chart, a flame chart, a time lapse chart or the like.

In practice, the performance characteristics module 210 and/or the statistical forecasting module 212 may be implemented with (or cooperate with) the at least one processor 202 to perform at least some of the functions and operations described in more detail herein. In this regard, the performance characteristics module 210 and/or the statistical forecasting module 212 may be realized as suitably written processing logic, application program code, or the like.

The display device 214 is configured to display various icons, text, and/or graphical elements associated with a software application “app builder” platform, reusable software components, performance scores for a software application page customized with reusable software components, and/or weighted performance scores associated with particular reusable software components, or the like. In an exemplary embodiment, the display device 214, the user interface 206, and the at least one processor 202 are communicatively coupled. The at least one processor 202, the user interface 206, and the display device 214 are cooperatively configured to display, render, or otherwise convey one or more graphical representations or images associated with performance scores and weighted performance scores on the display device 214, as described in greater detail below. In an exemplary embodiment, the display device 214 is realized as an electronic display configured to graphically display performance score data, as described herein. In some embodiments, the display device 214 is implemented as a display screen of a standalone, personal computing device (e.g., laptop computer, tablet computer). It will be appreciated that although the display device 214 may be implemented using a single display, certain embodiments may use additional displays (i.e., a plurality of displays) to accomplish the functionality of the display device 214 described herein.

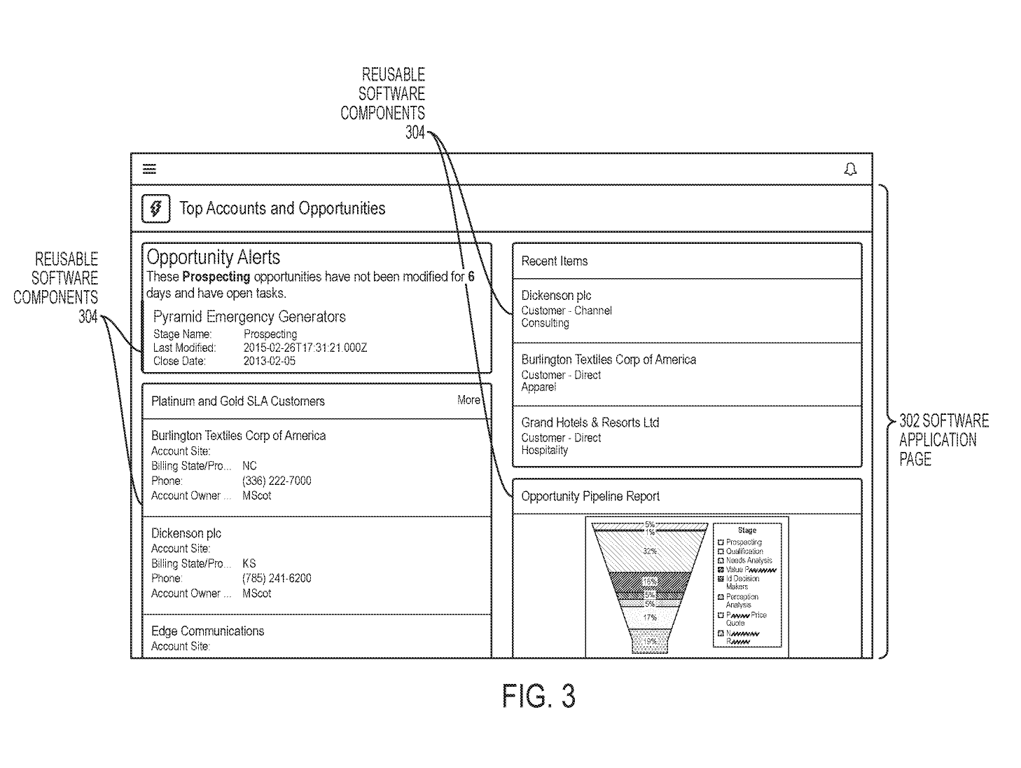

FIGS. 3-6 are diagrams of an embodiment of reusable software components and associated statistical forecasting data, in accordance with the disclosed embodiments. FIG. 3 is a diagram of a graphical user interface (GUI) 300 associated with a software application “app builder” platform. In this exemplary embodiment, the GUI 300 includes a software application page 302 that has been created, by a user, using reusable software components 304. The reusable software components 304 may also be referred to as components or reusable components. Reusable software components 304 are compact, configurable, and reusable elements that may be positioned (i.e., “dragged and dropped”) onto the software application page 302 in the software application builder environment or platform. Each of the reusable software components 304 are incorporated into the software application page 302 of a component-based web application, which is a software application comprising one or more components, and which may be implemented and accessible via an intranet or the Internet. One exemplary embodiment of a suitable environment is a Salesforce Lightning App Builder environment, including one or more Salesforce Lightning Pages which may be customized, by a user, through incorporation of one or more reusable software components 304. Here, using the software application builder platform, a user may customize the software application page 302 of the GUI 300 by incorporating one or more of the reusable software components 304, according to user preference.

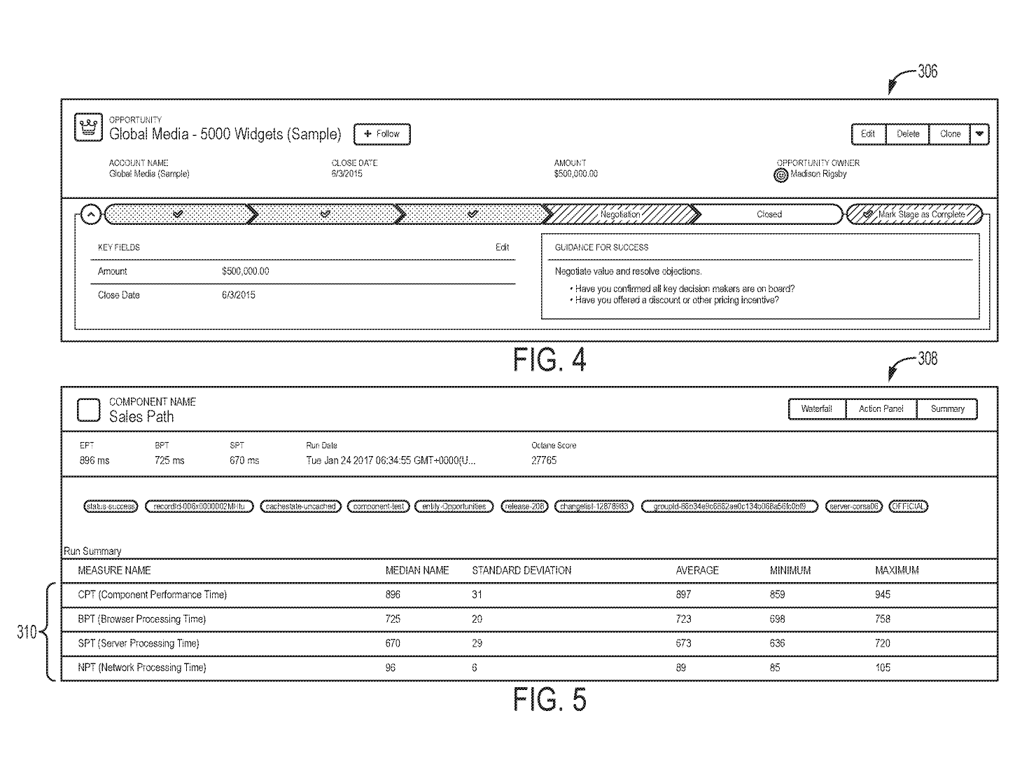

FIG. 4 is a diagram of a reusable software component 306, which may be incorporated into a software application page 302. In this particular example, when the reusable software component 306 is incorporated into the software application page 302 by a computer system (see reference 102, FIG. 1; reference 200, FIG. 2), then the computer system performs internal lab testing of the reusable software component 306 to obtain performance metrics data, as shown in FIG. 5.

FIG. 5 is a chart 308 of performance metrics 310, including a component performance time, a browser processing time, a server processing time, and a network processing time. It should be appreciated that FIG. 5 depicts a simplified embodiment of the chart 308, and that some implementations of the chart 308 may include additional performance metrics or other parameter data associated with the reusable software component 306 incorporated into the software application page 302.

Each layer of the software application is instrumented to enable capturing the performance characteristics for each user, and for each page. Software application layers include the client device (e.g., the computer system 200; see FIG. 1, reference 102), the network (see FIG. 1, reference 106), and the server communicating with the client device via the network (see FIG. 1, reference 104). Client device metrics may include, without limitation: browser processing time (e.g., render, layout, paint), Javascript execution time, component creation time, and component rendering time is instrumented for each component. Network metrics may include, without limitation: total network latency, request size, and response size are instrumented for each network/server request. Latency is the time taken from the source sending a packet to the destination receiving it. In exemplary embodiments of the software application, network latency for each server request is the time spent between the client device making a request and the client device receiving a response, excluding the time spent on the server. Server metrics may include, without limitation: total server response time and the breakdown of the server response time for each Application Programming Interface (API) and/or Structured Query Language (SQL) call on the server.

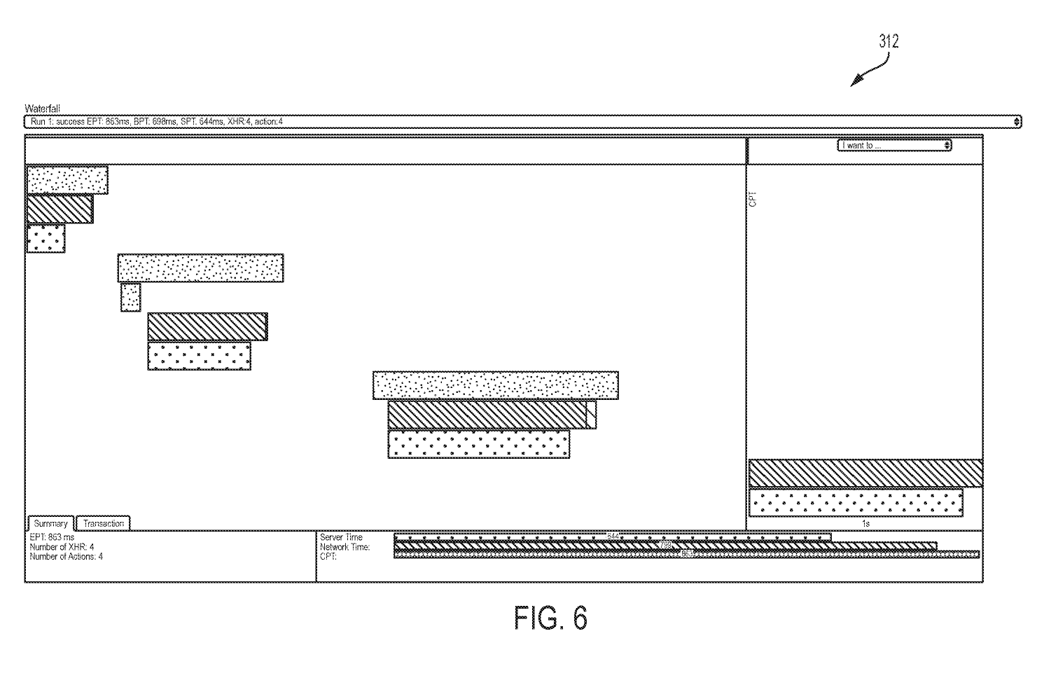

Based on the performance metrics 310 obtained through internal lab testing of the reusable software component 306, the computer system generates a statistical forecasting model to predict performance of the software application page 302. Exemplary embodiments of the statistical forecasting model may include a waterfall chart, such as the waterfall chart 312 shown in FIG. 6. Here, the waterfall chart 312 is computed based on the performance metrics 310 of the reusable software component 306. Additionally, the computer system may consider historical activity data of the user, which may change the data associated with the performance metrics 310 and the waterfall chart 312. Thus, in some embodiments, the waterfall chart 312 is computed based on (i) the performance metrics 310 of the reusable software component 306 and (ii) historical activity data of the user. Historical activity data of the user may include, without limitation, the user's operating system, browser preferences, user device characteristics, and network characteristics. Thus, FIGS. 3-6 illustrate one example of incorporating a reusable software component 306 into a software application page 302, obtaining performance metrics 310 associated with the reusable software component 306, and generating a statistical forecasting model (e.g., waterfall chart 312), from which a performance score may be determined.

It should be appreciated that more than one reusable software component 306 may be incorporated into a software application page 302, and that performance metrics 310 associated with each incorporated reusable software component 306 are used to generate a statistical forecasting model and to compute a performance score. When a user adds or removes a reusable software component 306 to customize the software application page 302, the statistical model (e.g., the waterfall chart 312) is used by the computer system to predict the loading time of the software application page 302. This loading time is indicated by the performance score.

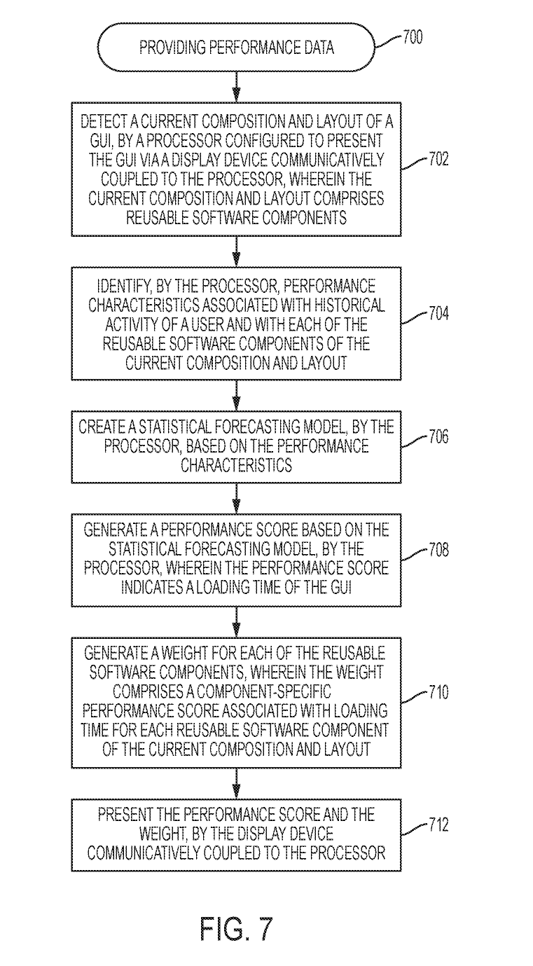

FIG. 7 is a flow chart that illustrates an embodiment of a process 700 for providing performance data, in accordance with the disclosed embodiments. In certain embodiments, the process 700 provides performance data in the form of a predictive performance score. First, the process 700 detects a current composition and layout of a graphical user interface (GUI), by a processor configured to present the GUI via a display device communicatively coupled to the processor, wherein the current composition and layout comprises a plurality of reusable software components (step 702). Generally, the processor and display device are implemented as a client device communicatively coupled to an application server, as described previously with regard to FIG. 1. The presented GUI is a “page” of the software application. A particular software application may include multiple pages, and each page of the software application may include multiple potential configurations. The current composition and layout includes one or more reusable software components that have been selected by a user, and incorporated by the user into the software application page. In certain embodiments, the process 700 detects the current composition and layout for one particular software application page (e.g., the GUI). In other embodiments, the process 700 detects the current composition and layout for every customizable page of the software application, wherein the software application includes multiple pages.

In some embodiments, the software application may be implemented as a website that includes a plurality of web pages, such as those included as part of, and presented by, the World Wide Web. Thus, the software application page may be implemented as a “web page”. Web pages are documents written in Hyper-Text Markup Language (HTML) and are translated by a Web browser for presentation to a user. Web pages can be static or dynamic. A static page continuously presents the same content each time the static page is viewed. A dynamic page includes content that can change each time the dynamic page is accessed. Web pages are typically written using scripting languages such as PHP, Perl, ASP, or JSP, and the scripts of each web page run functions on the server that return data, such as date, time, and database information.

Next, the process 700 identifies, by the processor, performance characteristics associated with historical activity of a user and with each of the reusable software components of the current composition and layout (step 704). Various embodiments of the performance characteristics may include server performance characteristics, network performance characteristics, client device performance characteristics, or the like. In some embodiments, the process 700 identifies server performance characteristics comprising at least a server response latency upon receipt of a communication is transmitted by the processor (i.e., the client computer system), wherein the performance characteristics comprises at least the server performance characteristics, wherein the statistical model is created using the server performance characteristics. In some embodiments, the process 700 identifies network performance characteristics comprising at least a network latency when a communication is transmitted by the processor, wherein the performance characteristics comprises at least the network performance characteristics, wherein the statistical model is created using the network performance characteristics. The network latency is the round-trip travel time for data transmissions (i.e., data messages) between the server and the client. In other words, the network latency includes a time period for a data message to be received by the server, after transmission from the client device to the server. Additionally, the network latency includes a time period for a data message to be received by the client device, after transmission from the server to the client device.

In some embodiments, the process 700 identifies client device performance characteristics comprising at least a client device latency associated with execution of operations and rendering graphical elements, wherein the first set of performance characteristics comprises at least the client device performance characteristics, wherein the statistical model is created using the client device performance characteristics. The client device latency is the time period required for client device processing of data received by the client device. In other words, the client device latency is the client processing time. Generally, all layers of the software application are instrumented to enable the process 700 capturing the performance characteristics for each user, for each page.

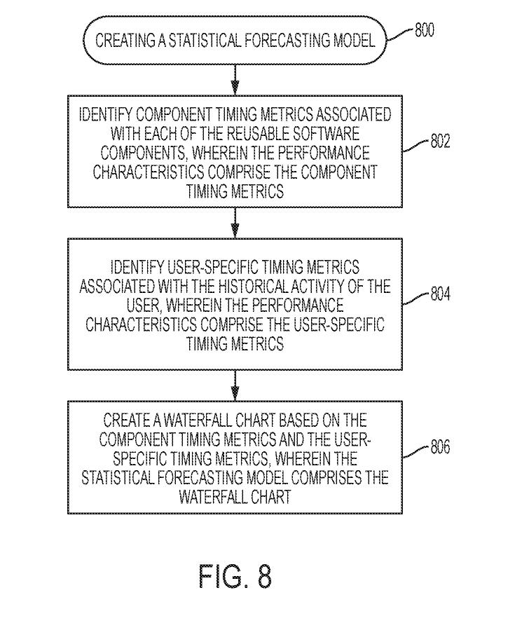

The process 700 then creates a statistical forecasting model, by the processor, based on the performance characteristics (step 706). One suitable methodology for creating a statistical forecasting model is described below with reference to FIG. 8. The process 700 generates the statistical forecasting model based on (i) performance data collected by the internal lab testing for different configurations, and (ii) performance data captured from a user's historical transactions.

Next, the process 700 generates a performance score based on the statistical forecasting model, by the processor, wherein the performance score indicates a loading time of the GUI (step 708) for the current configuration of reusable software components. In other words, the performance score indicates a loading time of the page of the software application, wherein the presented GUI is a page of the software application. In certain embodiments, the process 700 also generates a weight for each of the reusable software components, wherein the weight comprises a component-specific performance score associated with loading time for each reusable software component of the current configuration (step 710). However, in other embodiments, the process 700 generates a performance score as a standalone feature, which does not include a weight for each of the reusable software components.

The process 700 then presents the performance score and, in some embodiments, the weight, by the display device communicatively coupled to the processor (step 712). It should be appreciated that the performance score and the weight may be generated and presented individually (i.e., alone) or together as a combination presentation. User-customization of a page (i.e., user customization of the GUI) changes the performance score of the page. More specifically, the performance score varies based on the addition and/or removal of components, and the corresponding weight attributed to each component, to the page.

FIG. 8 is a flow chart that illustrates an embodiment of a process 800 for creating a statistical forecasting model, in accordance with the disclosed embodiments. It should be appreciated that the process 800 described in FIG. 8 represents one embodiment of step 706 described above in the discussion of FIG. 7, including additional detail.

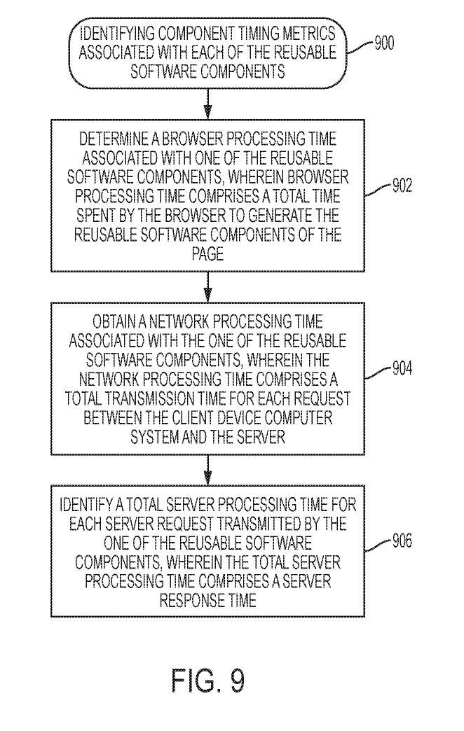

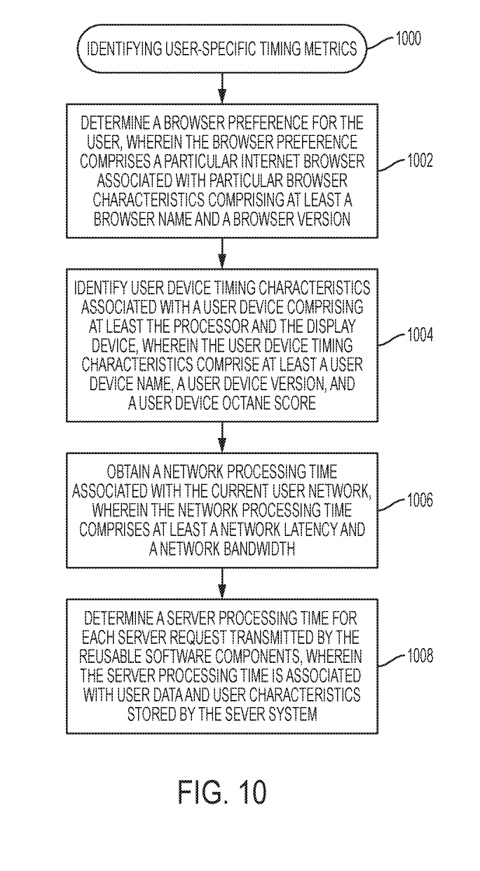

Here, the process 800 identifies component timing metrics associated with each of the reusable software components, wherein the performance characteristics comprise the component timing metrics (step 802). One suitable methodology for identifying component timing metrics is described below with reference to FIG. 9. The process 800 also identifies user-specific timing metrics associated with the historical activity of the user, wherein the performance characteristics comprise the user-specific timing metrics (step 804). One suitable methodology for identifying user-specific timing metrics is described below with reference to FIG. 10. As described herein, the component timing metrics are specific to one particular reusable software component, and the user-specific timing metrics are associated with previously detected user activity and timing data for user equipment operation, as related to execution of the software application builder platform, customization of the software application pages using reusable software components, timing of page-loading, component rendering, and execution of operations by the user equipment.

The process 800 then creates a waterfall chart based on the component timing metrics and the user-specific timing metrics, wherein the statistical forecasting model comprises the waterfall chart (step 806). Here, the process 800 obtains page load time data from the waterfall chart, and predicts the performance score of a configuration of reusable software components of a software application page, using the page load time data from the waterfall chart. The performance score is the page load time that is calculated based on the performance metrics of all components on the page.

FIG. 9 is a flow chart that illustrates an embodiment of a process 900 for identifying component timing metrics associated with each of the reusable software components, in accordance with the disclosed embodiments. It should be appreciated that the process 900 described in FIG. 9 represents one embodiment of step 802 described above in the discussion of FIG. 9, including additional detail.

The process 900 determines a browser processing time associated with one of the reusable software components, wherein the browser processing time comprises a total time spent by the browser of the client device computer system (see FIG. 1, reference 102) to generate each of the reusable software components of the page (step 902). Generating the reusable software components may include, without limitation, processing, creating, rendering, positioning each of the reusable software components as part of a page layout, painting the reusable software components of the page, or the like.

The process 900 also obtains a network processing time associated with the one of the reusable software components, wherein the network processing time comprises a total transmission time for each request between the client device computer system and the server (step 904). For example, a network processing time includes a time period after a request is transmitted from an origin device (from the client device to the server or from the server to the client device), and before the transmitted request is received at a destination device. Thus, the network processing time comprises a total time spent in the network layer and/or transport layer for each request between the client device and the server.

Additionally, the process 900 identifies a total server processing time for each server request transmitted by the one of the reusable software components, wherein the total server processing time comprises a server response time (step 906). In some embodiments, the total server processing time further comprises the breakdown of the server response time into time spent on each Application Programming Interface (API) and/or Structured Query Language (SQL) call on the server.

FIG. 10 is a flow chart that illustrates an embodiment of a process 1000 for identifying user-specific timing metrics, in accordance with the disclosed embodiments. It should be appreciated that the process 1000 described in FIG. 10 represents one embodiment of step 804 described above in the discussion of FIG. 8, including additional detail. The process 1000 determines a browser preference for the user, wherein the browser preference comprises a particular internet browser associated with particular browser characteristics comprising at least a browser name and a browser version (step 1002). The process 1000 also identifies user device timing characteristics associated with a user device comprising at least the processor and the display device, wherein the user device timing characteristics comprise at least a user device name, a user device version, and a user device octane score (step 1004).

Additionally, the process 1000 obtains a network processing time associated with the current user network, wherein the network processing time comprises at least a network latency and a network bandwidth (step 1006). The network processing time referenced in step 1006 is the same network processing time parameter described previously with regard to FIG. 9, step 904. The process 1000 also determines a server processing time for each server request transmitted by the reusable software components, wherein the server processing time is associated with user data and user characteristics stored by the server system (step 1008). The server processing time referenced in step 1008 is the same server processing time parameter described previously with regard to FIG. 9, step 906.

In some embodiments, the process 1000 determines that user-specific timing metrics are unavailable for the user, wherein the user-specific timing metrics comprise at least: a browser preference for the user, user device timing characteristics associated with a user device comprising at least the processor and the display device, a network processing time associated with a current user network, and a server processing time for each server request transmitted by the reusable software components. In this scenario, the process 700 accesses a database stored by the server system, via a communication connection from the processor, wherein the database includes default user-specific timing metrics, wherein the waterfall chart is created for the default user-specific timing metrics comprising at least a default browser preference, default user device timing characteristics, a default network processing time, and a default server processing time.

The various tasks performed in connection with processes 700-1000 may be performed by software, hardware, firmware, or any combination thereof. For illustrative purposes, the preceding description of processes 700-1000 may refer to elements mentioned above in connection with FIGS. 1-6. In practice, portions of processes 700-1000 may be performed by different elements of the described system. It should be appreciated that processes 700-1000 may include any number of additional or alternative tasks, the tasks shown in FIGS. 7-10 need not be performed in the illustrated order, and processes 700-1000 may be incorporated into a more comprehensive procedure or process having additional functionality not described in detail herein. Moreover, one or more of the tasks shown in FIGS. 7-10 could be omitted from embodiments of the processes 700-1000 as long as the intended overall functionality remains intact.

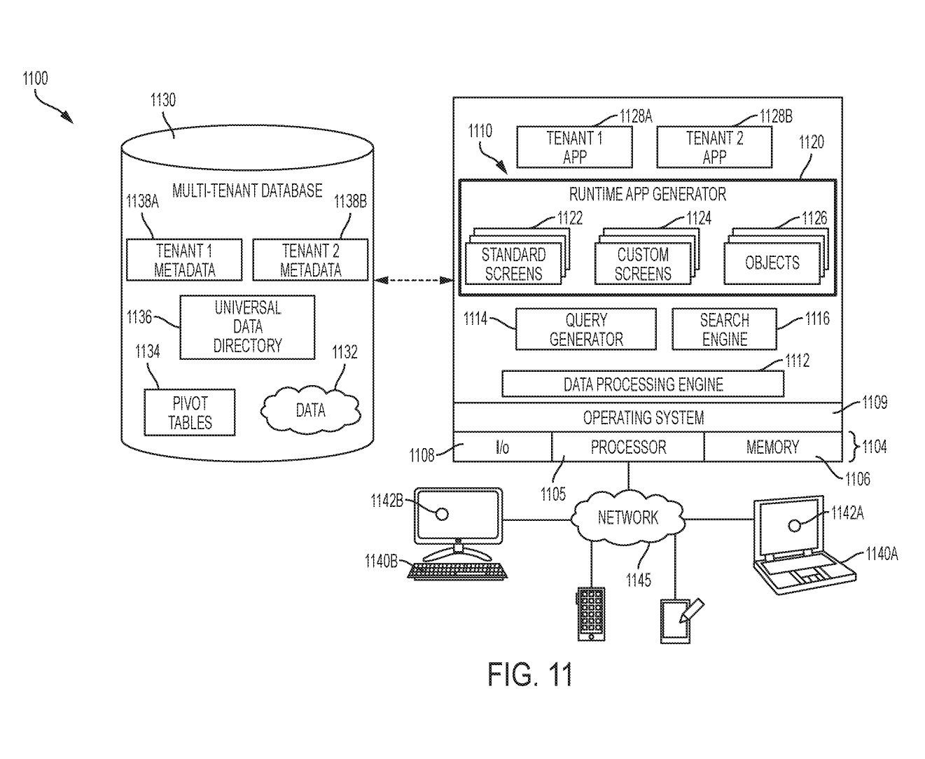

FIG. 11 is a conceptual block diagram of a multi-tenant system 1100 in accordance with the disclosed embodiments. The multi-tenant system 1100 FIG. 11 may be used in cloud computing applications and multi-tenant system applications, wherein users can access a software application (including multiple pages of the software application) from a plurality of client device user interfaces (e.g., desktop, phone, tablet computer). The performance load time for each page with each of the user devices can vary based on the configuration of each of the disclosed embodiments. Contemplated herein is a system and process for predicting the page load time for each of these configurations of the multi-tenant system.

The multi-tenant system 1100 may be used to in conjunction with the CRM software applications described previously. Platform as a Service (PaaS) is the foundation of the multi-tenant architecture. At the heart, this PaaS is a relational database management system. All of the core mechanisms in a relational database management system (RDBMS) (e.g., a system catalog, caching mechanisms, query optimizer, and application development features) are built to support multi-tenant applications and to be run directly on top of a specifically tuned host operating system and raw hardware. The runtime engine has the intelligence to access the metadata and transactional data and perform the application functionality that can scale.

The multi-tenant system 1100 of FIG. 11 includes a server 1102 that dynamically creates and supports virtual applications 1128 based upon data 1132 from a common database 1130 that is shared between multiple tenants, alternatively referred to herein as a multi-tenant database. Data and services generated by the virtual applications 1128 are provided via a network 1145 to any number of client devices 1140, as desired. Each virtual application 1128 is suitably generated at run-time (or on-demand) using a common application platform 1110 that securely provides access to the data 1132 in the database 1130 for each of the various tenants subscribing to the multi-tenant system 1100. In accordance with one non-limiting example, the multi-tenant system 1100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 1130. In this regard, each tenant includes one or more users associated with, assigned to, or otherwise belonging to that respective tenant. To put it another way, each respective user within the multi-tenant system 1100 is associated with, assigned to, or otherwise belongs to a particular tenant of the plurality of tenants supported by the multi-tenant system 1100. Tenants may represent customers, customer departments, business or legal organizations, and/or any other entities that maintain data for particular sets of users within the multi-tenant system 1100 (i.e., in the multi-tenant database 1130). For example, the application server 1102 may be associated with one or more tenants supported by the multi-tenant system 1100. Although multiple tenants may share access to the server 1102 and the database 1130, the particular data and services provided from the server 1102 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 1132 belonging to or otherwise associated with other tenants.

The multi-tenant database 1130 is any sort of repository or other data storage system capable of storing and managing the data 1132 associated with any number of tenants. The database 1130 may be implemented using any type of conventional database server hardware. In various embodiments, the database 1130 shares processing hardware 1104 with the server 1102. In other embodiments, the database 1130 is implemented using separate physical and/or virtual database server hardware that communicates with the server 1102 to perform the various functions described herein. In an exemplary embodiment, the database 1130 includes a database management system or other equivalent software capable of determining an optimal query plan for retrieving and providing a particular subset of the data 1132 to an instance of virtual application 1128 in response to a query initiated or otherwise provided by a virtual application 1128. The multi-tenant database 1130 may alternatively be referred to herein as an on-demand database, in that the multi-tenant database 1130 provides (or is available to provide) data at run-time to on-demand virtual applications 1128 generated by the application platform 1110.

In practice, the data 1132 may be organized and formatted in any manner to support the application platform 1110. In various embodiments, the data 1132 is suitably organized into a relatively small number of large data tables to maintain a semi-amorphous “heap”-type format. The data 1132 can then be organized as needed for a particular virtual application 1128. In various embodiments, conventional data relationships are established using any number of pivot tables 1134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 1136, for example, can be used to describe any number of forms, reports, workflows, user access privileges, business logic and other constructs that are common to multiple tenants. Tenant-specific formatting, functions and other constructs may be maintained as tenant-specific metadata 1138 for each tenant, as desired. Rather than forcing the data 1132 into an inflexible global structure that is common to all tenants and applications, the database 1130 is organized to be relatively amorphous, with the pivot tables 1134 and the metadata 1138 providing additional structure on an as-needed basis. To that end, the application platform 1110 suitably uses the pivot tables 1134 and/or the metadata 1138 to generate “virtual” components of the virtual applications 1128 to logically obtain, process, and present the relatively amorphous data 1132 from the database 1130.

The server 1102 is implemented using one or more actual and/or virtual computing systems that collectively provide the dynamic application platform 1110 for generating the virtual applications 1128. For example, the server 1102 may be implemented using a cluster of actual and/or virtual servers operating in conjunction with each other, typically in association with conventional network communications, cluster management, load balancing and other features as appropriate. The server 1102 operates with any sort of conventional processing hardware 1104, such as a processor 1105, memory 1106, input/output features 1108 and the like. The input/output features 1108 generally represent the interface(s) to networks (e.g., to the network 1145, or any other local area, wide area or other network), mass storage, display devices, data entry devices and/or the like. The processor 1105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 1106 represents any non-transitory short or long term storage or other computer-readable media capable of storing programming instructions for execution on the processor 1105, including any sort of random access memory (RAM), read only memory (ROM), flash memory, magnetic or optical mass storage, and/or the like. The computer-executable programming instructions, when read and executed by the server 1102 and/or processor 1105, cause the server 1102 and/or processor 1105 to create, generate, or otherwise facilitate the application platform 1110 and/or virtual applications 1128 and perform one or more additional tasks, operations, functions, and/or processes described herein. It should be noted that the memory 1106 represents one suitable implementation of such computer-readable media, and alternatively or additionally, the server 1102 could receive and cooperate with external computer-readable media that is realized as a portable or mobile component or application platform, e.g., a portable hard drive, a USB flash drive, an optical disc, or the like.

The application platform 1110 is any sort of software application or other data processing engine that generates the virtual applications 1128 that provide data and/or services to the client devices 1140. In a typical embodiment, the application platform 1110 gains access to processing resources, communications interfaces and other features of the processing hardware 1104 using any sort of conventional or proprietary operating system 1109. The virtual applications 1128 are typically generated at run-time in response to input received from the client devices 1140. For the illustrated embodiment, the application platform 1110 includes a bulk data processing engine 1112, a query generator 1114, a search engine 1116 that provides text indexing and other search functionality, and a runtime application generator 1120. Each of these features may be implemented as a separate process or other module, and many equivalent embodiments could include different and/or additional features, components or other modules as desired.

The runtime application generator 1120 dynamically builds and executes the virtual applications 1128 in response to specific requests received from the client devices 1140. The virtual applications 1128 are typically constructed in accordance with the tenant-specific metadata 1138, which describes the particular tables, reports, interfaces and/or other features of the particular application 1128. In various embodiments, each virtual application 1128 generates dynamic web content that can be served to a browser or other client program 1142 associated with its client device 1140, as appropriate.

The runtime application generator 1120 suitably interacts with the query generator 1114 to efficiently obtain multi-tenant data 1132 from the database 1130 as needed in response to input queries initiated or otherwise provided by users of the client devices 1140. In a typical embodiment, the query generator 1114 considers the identity of the user requesting a particular function (along with the user's associated tenant), and then builds and executes queries to the database 1130 using system-wide metadata 1136, tenant specific metadata 1138, pivot tables 1134, and/or any other available resources. The query generator 1114 in this example therefore maintains security of the common database 1130 by ensuring that queries are consistent with access privileges granted to the user and/or tenant that initiated the request. In this manner, the query generator 1114 suitably obtains requested subsets of data 1132 accessible to a user and/or tenant from the database 1130 as needed to populate the tables, reports or other features of the particular virtual application 1128 for that user and/or tenant.

Still referring to FIG. 11, the data processing engine 1112 performs bulk processing operations on the data 1132 such as uploads or downloads, updates, online transaction processing, and/or the like. In many embodiments, less urgent bulk processing of the data 1132 can be scheduled to occur as processing resources become available, thereby giving priority to more urgent data processing by the query generator 1114, the search engine 1116, the virtual applications 1128, etc.

In exemplary embodiments, the application platform 1110 is utilized to create and/or generate data-driven virtual applications 1128 for the tenants that they support. Such virtual applications 1128 may make use of interface features such as custom (or tenant-specific) screens 1124, standard (or universal) screens 122 or the like. Any number of custom and/or standard objects 1126 may also be available for integration into tenant-developed virtual applications 1128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 1126 such as “account” objects, “opportunity” objects, “contact” objects, or the like. The data 1132 associated with each virtual application 1128 is provided to the database 1130, as appropriate, and stored until it is requested or is otherwise needed, along with the metadata 1138 that describes the particular features (e.g., reports, tables, functions, objects, fields, formulas, code, etc.) of that particular virtual application 1128. For example, a virtual application 1128 may include a number of objects 1126 accessible to a tenant, wherein for each object 1126 accessible to the tenant, information pertaining to its object type along with values for various fields associated with that respective object type are maintained as metadata 1138 in the database 1130. In this regard, the object type defines the structure (e.g., the formatting, functions and other constructs) of each respective object 1126 and the various fields associated therewith.

Still referring to FIG. 11, the data and services provided by the server 1102 can be retrieved using any sort of personal computer, mobile telephone, tablet or other network-enabled client device 1140 on the network 1145. In an exemplary embodiment, the client device 1140 includes a display device, such as a monitor, screen, or another conventional electronic display capable of graphically presenting data and/or information retrieved from the multi-tenant database 1130. Typically, the user operates a conventional browser application or other client program 1142 executed by the client device 1140 to contact the server 1102 via the network 1145 using a networking protocol, such as the hypertext transport protocol (HTTP) or the like. The user typically authenticates his or her identity to the server 1102 to obtain a session identifier (“SessionID”) that identifies the user in subsequent communications with the server 1102. When the identified user requests access to a virtual application 1128, the runtime application generator 1120 suitably creates the application at run time based upon the metadata 1138, as appropriate. As noted above, the virtual application 1128 may contain Java, ActiveX, or other content that can be presented using conventional client software running on the client device 1140; other embodiments may simply provide dynamic web or other content that can be presented and viewed by the user, as desired.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for providing performance data, the method comprising:
detecting a current composition and layout of a graphical user interface (GUI), by a processor configured to present the GUI via a display device communicatively coupled to the processor, wherein the current composition and layout comprises reusable software components;
identifying, by the processor, performance characteristics associated with historical activity of a user and with each of the reusable software components of the current composition and layout;
creating a statistical forecasting model, by the processor, based on the performance characteristics;
generating a performance score based on the statistical forecasting model, by the processor, wherein the performance score indicates a loading time of the GUI; and
presenting the performance score, by the display device communicatively coupled to the processor.

2. The method of claim 1, further comprising:
identifying server performance characteristics comprising at least a server response latency upon receipt of a communication is transmitted by the processor, wherein the performance characteristics comprises at least the server performance characteristics;
wherein the statistical model is created using the server performance characteristics.

3. The method of claim 1, further comprising:
identifying network performance characteristics comprising at least a network latency when a communication is transmitted by the processor, wherein the performance characteristics comprises at least the network performance characteristics;
wherein the statistical model is created using the ne

[symbol]

4. The method of claim 1, further comprising:
identifying client device performance characteristics comprising at least a client device latency associated with execution of operations and rendering graphical elements, wherein the first set of performance characteristics comprises at least the client device performance characteristics;
wherein the statistical model is created using the client device performance characteristics.

5. The method of claim 1, further comprising:
generating a weight for each of the reusable software components, wherein the weight comprises a component-specific performance score associated with loading time for each reusable software component of the current composition and layout, and wherein the performance score is associated with the loading time of the GUI for the current composition and layout; and
presenting the weight and the performance score, by the display device.

6. The method of claim 1, wherein creating the statistical forecasting model further comprises:
identifying component timing metrics associated with each of the reusable software components, wherein the performance characteristics comprise the component timing metrics; and
identifying user-specific timing metrics associated with the historical activity of the user, wherein the performance characteristics comprise the user-specific timing metrics; and
creating a waterfall chart based on the component timing metrics and the user-specific timing metrics, wherein the statistical forecasting model comprises the waterfall chart.

7. The method of claim 6, wherein identifying component timing metrics further comprises:
determining a browser processing time associated with one of the reusable software components, wherein the browser processing time comprises a total time spent by the browser to generate the reusable software components of the page;
obtaining a network processing time associated with the one of the reusable software components, wherein the network processing time comprises a total transmission time for each request between the client device computer system and the server; and
identifying a total server processing time for each server request transmitted by the one of the reusable software components, wherein the total server processing time comprises a server response time;
wherein the waterfall chart is created for the component timing metrics associated with the one of the reusable software components, based on the browser processing time, the network processing time, and the total server processing time.

8. The method of claim 6, wherein identifying user-specific timing metrics further comprises:
determining a browser preference for the user, wherein the browser preference comprises a particular internet browser associated with particular browser characteristics comprising at least a browser name and a browser version;
identifying user device timing characteristics associated with a user device comprising at least the processor and the display device, wherein the user device timing characteristics comprise at least a user device name, a user device version, and a user device octane score;
obtaining a network processing time associated with a current user network, wherein the network processing time comprises at least a network latency and a network bandwidth; and
determining a server processing time for each server request transmitted by the reusable software components, wherein the server processing time is associated with user data and user characteristics stored by the server system;
wherein the waterfall chart is created for the user-specific timing metrics, based on the browser preference, the user device timing characteristics, the network processing time, and the server processing time.

9. The method of claim 6, wherein identifying user-specific timing metrics further comprises:
determining that user-specific timing metrics are unavailable for the user, wherein the user-specific timing metrics comprise at least:
a browser preference for the user, wherein the browser preference comprises a particular internet browser associated with particular browser characteristics comprising at least a browser name and a browser version;
user device timing characteristics associated with a user device comprising at least the processor and the display device, wherein the user device timing characteristics comprise at least a user device name, a user device version, and a user device octane score;
a network processing time associated with a current user network, wherein the network processing time comprises at least a network latency and a network bandwidth; and
a server processing time for each server request transmitted by the reusable software components, wherein the server processing time is associated with user data and user characteristics stored by the server system; and
accessing a database stored by the server system, via a communication connection from the processor, wherein the database includes default user-specific timing metrics;
wherein the waterfall chart is created for the default user-specific timing metrics comprising at least a default browser preference, default user device timing characteristics, a default network processing time, and a default server processing time.

10. A computing device for providing performance data, the computing device comprising:
a system memory element;
a communication device, configured to establish a communication connection to a server system configured to store historical activity of a user;
a display device, configured to present the performance data and a graphical user interface (GUI) comprising reusable software components; and
at least one processor, communicatively coupled to the system memory element, the communication device, and the display device, the at least one processor configured to:
detect a current composition and layout of reusable software components of a graphical user interface (GUI);
identify performance characteristics associated with historical activity of a user and with each of the reusable software components of the current composition and layout;
create a statistical forecasting model, by the processor, based on the performance characteristics;
generate a performance score based on the statistical forecasting model, by the processor, wherein the performance score indicates a loading time of the GUI; and
present the performance score, via the display device.

11. The computing device of claim 10, wherein the at least one processor is further configured to:
identify server performance characteristics comprising at least a server response latency upon receipt of a communication is transmitted by the processor, wherein the performance characteristics comprises at least the server performance characteristics;
wherein the statistical model is created using the server performance characteristics.

12. The computing device of claim 10, wherein the at least one processor is further configured to:
identify network performance characteristics comprising at least a network latency when a communication is transmitted by the processor, wherein the performance characteristics comprises at least the network performance characteristics;
wherein the statistical model is created using the network performance characteristics.

13. The computing device of claim 10, wherein the at least one processor is further configured to:
identify client device performance characteristics comprising at least a client device latency associated with execution of operations and rendering graphical elements, wherein the performance characteristics comprises at least the client device performance characteristics;
wherein the statistical model is created using the client device performance characteristics.

14. The computing device of claim 10, wherein the at least one processor is further configured to:
generate a weight for each of the reusable software components, wherein the weight comprises a component-specific performance score associated with loading time for each reusable software component of the current composition and layout, and wherein the performance score is associated with the loading time of the GUI for the current composition and layout; and
present the weight and the performance score, by the display device.

15. The computing device of claim 10, wherein the at least one processor is further configured to:
identify component timing metrics associated with each of the reusable software components, wherein the performance characteristics comprise the component timing metrics, by:
determining a browser processing time associated with one of the reusable software components, wherein the browser processing time comprises a total time spent by the browser to generate the reusable software components of the page;
obtaining a network processing time associated with the one of the reusable software components, wherein the network processing time comprises a total transmission time for each request between the client device computer system and the server; and
identifying a total server processing time for each server request transmitted by the one of the reusable software components, wherein the total server processing time comprises a server response time; and
create a waterfall chart for at least the component timing metrics associated with the one of the reusable software components, based on the browser processing time, the network processing time, and the total server processing time;
wherein the statistical forecasting model comprises the waterfall chart.

16. The computing device of claim 10, wherein the at least one processor is further configured to:
identify user-specific timing metrics associated with the historical activity of the user, wherein the performance characteristics comprise the user-specific timing metrics, by:
determining a browser preference for the user, wherein the browser preference comprises a particular internet browser associated with particular browser characteristics comprising at least a browser name and a browser version;
identifying user device timing characteristics associated with a user device comprising at least the processor and the display device, wherein the user device timing characteristics comprise at least a user device name, a user device version, and a user device octane score;
obtaining a network processing time associated with a current user network, wherein the network processing time comprises at least a network latency and a network bandwidth; and
determining a server processing time for each server request transmitted by the reusable software components, wherein the server processing time is associated with user data and user characteristics stored by the server system; and
create a waterfall chart for the user-specific timing metrics, based on the browser preference, the user device timing characteristics, the network processing time, and the server processing time;
wherein the statistical forecasting model comprises the waterfall chart.

17. A non-transitory, computer-readable medium containing instructions thereon, the instructions being configurable to be executed by a processor to perform a method comprising:
detecting a current composition and layout of a graphical user interface (GUI), by the processor configured to present the GUI via a display device communicatively coupled to the processor, wherein the current composition and layout comprises reusable software components;
identifying component timing metrics associated with each of the reusable software components, by the processor;
measuring user-specific timing metrics associated with the historical activity of the user, by the processor;
creating a statistical forecasting model, by the processor, based on the component timing metrics and the user-specific timing metrics, wherein the statistical forecasting model comprises a waterfall chart of the component timing metrics and the user-specific timing metrics;
generating a performance score based on the statistical forecasting model, by the processor, wherein the performance score indicates a loading time of the GUI; and
presenting the performance score, by the display device communicatively coupled to the processor.

18. The non-transitory, computer-readable medium of claim 17, wherein identifying component timing metrics further comprises:
determining a browser processing time associated with one of the reusable software components, wherein the browser processing time comprises a total time spent by the browser to generate the reusable software components of the page;
obtaining a network processing time associated with the one of the reusable software components, wherein the network processing time comprises a total transmission time for each request between the client device computer system and the server; and
identifying a total server processing time for each server request transmitted by the one of the reusable software components, wherein the total server processing time comprises a server response time; and
wherein the waterfall chart is created for the component timing metrics associated with the one of the reusable software components, based on the browser processing time, the network processing time, and the total server processing time.

19. The non-transitory, computer-readable medium of claim 17, wherein measuring user-specific timing metrics further comprises:
determining a browser preference for the user, wherein the browser preference comprises a particular internet browser associated with particular browser characteristics comprising at least a browser name and a browser version;
identifying user device timing characteristics associated with a user device comprising at least the processor and the display device, wherein the user device timing characteristics comprise at least a user device name, a user device version, and a user device octane score;
obtaining a network processing time associated with a current user network, wherein the network processing time comprises at least a network latency and a network bandwidth; and
determining a server processing time for each server request transmitted by the reusable software components, wherein the server processing time is associated with user data and user characteristics stored by the server system;
wherein the waterfall chart is created for the user-specific timing metrics, based on the browser preference, the user device timing characteristics, the network processing time, and the server processing time.

20. The non-transitory, computer-readable medium of claim 17, wherein measuring user-specific timing metrics further comprises:
determining that user-specific timing metrics are unavailable for the user, wherein the user-specific timing metrics comprise at least:
a browser preference for the user, wherein the browser preference comprises a particular internet browser associated with particular browser characteristics comprising at least a browser name and a browser version;
user device timing characteristics associated with a user device comprising at least the processor and the display device, wherein the user device timing characteristics comprise at least a user device name, a user device version, and a user device octane score;
a network processing time associated with a current user network, wherein the network processing time comprises at least a network latency and a network bandwidth; and
a server processing time for each server request transmitted by the reusable software components, wherein the server processing time is associated with user data and user characteristics stored by the server system;
accessing a database stored by the server system, via the communication connection, wherein the database includes default user-specific timing metrics;
wherein the waterfall chart is created for the default user-specific timing metrics comprising at least a default browser preference, default user device timing characteristics, a default network processing time, and a default server processing time.
